(19) United States
(12) Patent Application Publication
(10) Pub. No.: US 2007/0248787 A1
(43) Pub. Date: Oct. 25, 2007

(54) Artificial leather

(76) Inventor: Su Jen Chou, Ho Mei Town (TW)

Correspondence Address: CHARLES E. BAXLEY, ESQ., 90 JOHN STREET, THIRD FLOOR, NEW YORK, NY, 10038, US

(21) Appl. No.: 11/409,619

(22) Filed: Apr. 24, 2006

(51) Int. Cl. B32B 33/00; B32B 3/02

(52) U.S. Cl. 428/91; 428/96

(57) ABSTRACT

An artificial leather includes a basic layer having a number of longitudinal filaments and a number of lateral filaments perpendicular to the longitudinal filaments and coupled to the longitudinal filaments, the filaments are formed by a thread having a wax outer layer. A cover layer is secured onto the basic layer, and includes a number of hair members provided on top to form a hairy structure, and includes a PU material engaged into the cover layer, to form the artificial leather. The wax outer layer is removed from the basic layer after the PU material has been engaged into the cover layer, to allow the basic layer to comfortably contact with users, and to prevent the users from contacting with the PU material.

### BACKGROUND OF THE INVENTION

1. Field of the Invention

The present invention relates to an artificial leather including a cloth inner or basic layer having a number of longitudinal and lateral filaments coupled together and formed by a thread applied with a wax outer layer, a cover layer secured onto the basic layer and having a number of hair members provided on top to form a hairy structure, and a PU material applied onto the hair members of the cover layer to form the artificial leather, the wax outer layer may be removed from the basic layer after the PU material has been engaged onto the cover layer, to prevent the PU material from being engaged into the basic layer, to decrease a weight of the basic layer, and to provide an air circulating effect to the basic layer, and to allow the basic layer to comfortably contact with users, and to prevent the PU material or the rubber or chemical or artificial outer layer from being directly contacting with users.

2. Description of the Prior Art

Due to environmental problems or for protecting our environment, and due to our booming of industrial techniques nowadays, the requirement of the true or natural leathers has been decreased, and the artificial leather products or cloth products have been widely used instead, and even to replace the true or natural leathers. The artificial leather products or cloth products not only imitate but also supersede the true or natural leathers, and the applicability of the artificial leather products or cloth products has broke through the limitation of the traditional true or natural leathers and has been widely used in various industrial fields or techniques.

In some of the countries, such as Japan, have employed the high technical manufacturing processes for treating the artificial fibers, woven or non-woven fabrics, to develop various kinds of non-woven basic fabrics, and some pre-treating processes, resin processing, dying, aft-treatment, etc. have further been operated to make the artificial leather products or cloth products to imitate and to replace the true or natural leathers, and even to supersede the artificial leather products or cloth products.

The touch, the outer appearance, the air breathing or permeability, and the water splashing of the artificial leather products or cloth products not only imitate but also supersede that of the true or natural leathers, and the manufacturing and the applicability of the artificial leather products or cloth products have also superseded the traditional true or natural leathers and even may not be compared or matched by the traditional true or natural leathers.

In the typical artificial leather manufacturing techniques, the non-woven basic fabrics have been completely or totally immersed in polyurethane (PU) material to allow the PU material to be entirely or fully absorbed into both the inner and the outer layers of the non-woven basic fabrics. However, the PU material is a chemical product and may be allergic when contacting with the skin of human beings, such that an inner cloth layer is further required to be attached onto the non-woven basic fabrics for separating the skin of human beings from the chemical PU material.

However, the additional inner cloth layer may increase the manufacturing cost to the artificial leather products or cloth products, the air breathing or permeability may also be affected. In addition, the non-woven basic fabrics are required to be completely or totally immersed in the PU material such that the consumption of the PU material is greatly increased, and such that the artificial leather products or cloth products are not suitable for industrial uses or applicability.

The present invention has arisen to mitigate and/or obviate the afore-described disadvantages of the conventional artificial leather products.

### SUMMARY OF THE INVENTION

The primary objective of the present invention is to provide an artificial leather for imitating the true or natural leathers, and allowing the artificial leather to have a lighter weight, a better softness, and an increased air breathing or permeability, for increasing the leather-like effect.

The other objective of the present invention is to provide an artificial leather for avoiding an additional inner basic cloth layer for further decreasing the weight of the artificial leather, and for applying the PU material onto an outer cover layer to decrease the using and the quantity of the PU material and thus for decreasing the weight and the manufacturing cost of the artificial leather.

The further objective of the present invention is to provide an artificial leather including a wax outer layer applied on a cloth inner or basic layer and to be removed from the cloth inner or basic layer after the PU material has been engaged into the outer cover layer, to prevent the covering of the PU material onto the cloth inner or basic layer, and to decrease the weight of the artificial leather, and to form a number of perforations in the cloth inner or basic layer, for facilitating air circulating effect to the artificial leather.

In accordance with one aspect of the invention, there is provided an artificial leather comprising a basic layer including a plurality of longitudinal filaments and a plurality of lateral filaments coupled to the longitudinal filaments, the longitudinal and the lateral filaments are formed by a thread having a wax outer layer applied thereon, a cover layer is secured onto the basic layer, and includes a plurality of hair members provided on top thereof, to form a hairy structure, and a PU material is then engaged and applied onto the hair members of the cover layer, to form the artificial leather, and the wax outer layer is removed from the basic layer after the PU material has been engaged onto the cover layer, to prevent the PU material from being engaged into the basic layer, to decrease a weight of the basic layer, and to provide an air circulating effect to the basic layer, and to allow the basic layer to comfortably contact with users, and to prevent the PU material from being directly contacting with users.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an artificial leather in accordance with the present invention;

FIG. 2 is an enlarged partial perspective view illustrating a stitching or coupling operation for forming or manufacturing the basic fabric layer of the artificial leather;

FIG. 3 is an enlarged exploded view of the artificial leather;

FIG. 4 is a perspective view of the artificial leather;

FIG. 5 is an enlarged partial cross sectional view taken along lines 5-5 of FIG. 4; and

FIGS. 6, 7, 8, 9, 10, 11 are enlarged partial cross sectional views similar to FIG. 5, illustrating the manufacturing process of the artificial leather.

### DETAILED DESCRIPTION OF THE PREFERRED EMBODIMENT

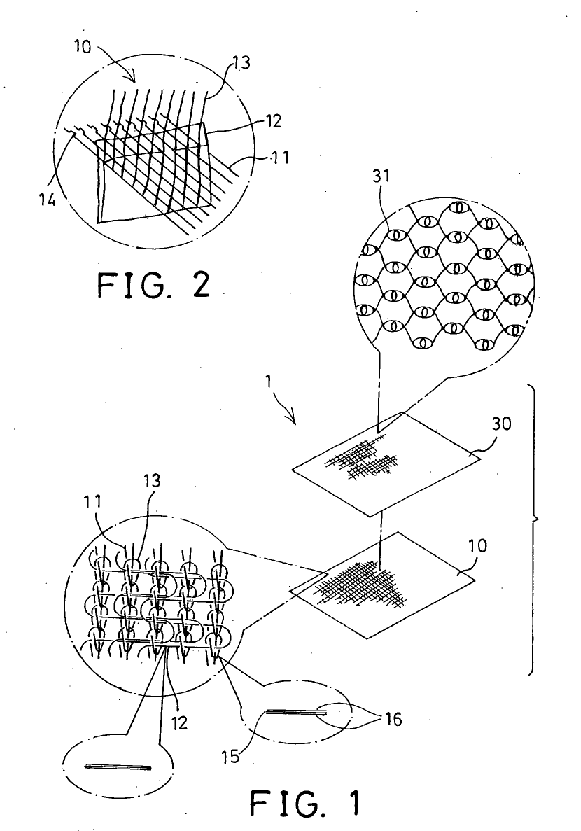

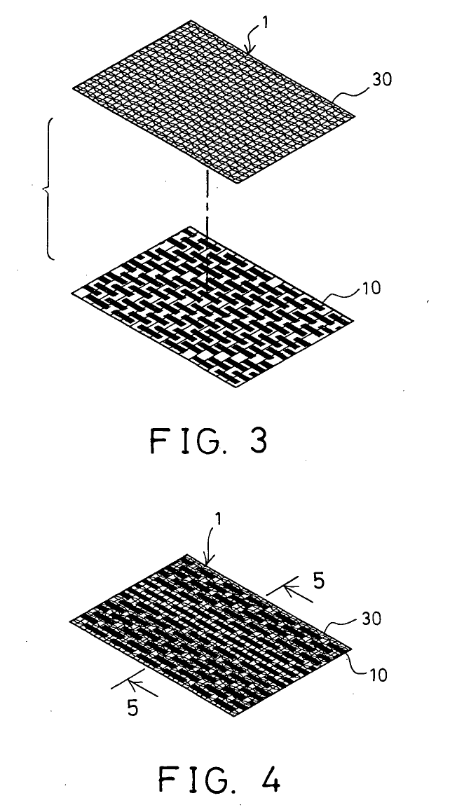

Referring to the drawings, and initially to FIGS. 1-5, an artificial leather 1 in accordance with the present invention comprises a basic layer 10, such as a basic cloth or fabric layer 10, which may be formed or made by woven or non-woven fibers or layers. For example, the basic cloth or fabric layer 10 includes a number of longitudinal filaments 11, and a number of lateral filaments 12 perpendicular to the longitudinal filaments 11, and coupled to or woven to the longitudinal filaments 11 with wound or coupling filaments 13 (FIG. 2).

The filaments 11, 12, 13 may be formed or manufactured by warp knitting or stitching operations with needles 14 or the like, and may be formed by fibers or threads 15 (FIGS. 1, 5-11), to form a woven cloth layer having a number of perforations in the cloth inner or basic layer, for facilitating air circulating effect to the artificial leather. Alternatively, the filaments 11, 12, 13 may also be formed or manufactured as a nonwoven cloth layer having a number of perforations in the cloth inner or basic layer, for facilitating air circulating effect to the artificial leather. The fibers or threads 15 may be applied thereon or covered with a wax outer layer 16 (FIGS. 1, 6-10), to protect the fibers or threads 15.

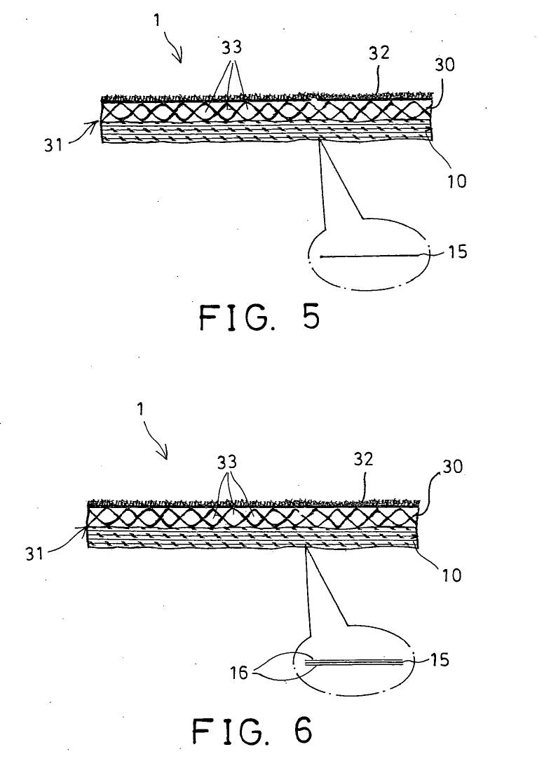

The artificial leather 1 further includes a cover layer 30 or an outer cover layer 30 which may also be formed or made by woven or non-woven fibers or layers 31 (FIGS. 1, 5-11), or which may also be formed by warp knitting or stitching operations. The cover layer 30 further includes a number of fine hair members 32 formed or provided on the woven or non-woven fibers or layers 31, such as provided on top thereof, to form a hairy structure 32, best shown in FIGS. 5-11, and to form a prototype as shown in FIGS. 5-6. The fibers or threads 15 may be applied with the wax outer layer 16 first before forming the prototype as shown in FIG. 6, or the fibers or threads 15 may first be formed into the prototype as shown in FIG. 5 and then applied the wax outer layer 16 onto the fibers or threads 15.

The cover layer 30 preferably includes a number of perforations 33 formed therein, such as formed by warp knitting or stitching operations with needles 14 or the like, for facilitating air circulating effect to the cover layer 30 of the artificial leather. The cover layer 30 and the basic layer 10 may then be secured together by such as stitching operations, to solidly secure the cover layer 30 and the basic layer 10 together, and to allow the perforations 33 to be formed and maintained within the cover layer 30 and the basic layer 10 and for facilitating the air circulation effect to the artificial leather.

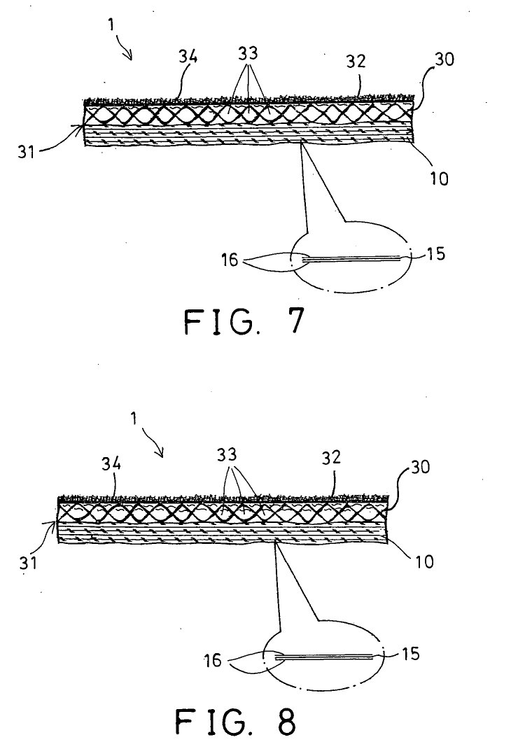

The artificial leather 1, including the basic layer 10 and the cover layer 30, is then treated with or dipped in polyurethane (PU) solutions or materials 34, as shown in FIG. 7, or has the PU materials 34 engaged onto the cover layer 30, particularly engaged onto the fibers or threads of the hair members 32 or the hairy structure 32 of the cover layer 30, to form or to simulate artificial leather products. At the moment as shown in FIG. 7, the PU materials 34 are engaged or applied onto the fibers or threads of the hair members 32 or the hairy structure 32 of the cover layer 30 only, but not completely filled within or blocked the perforations 33 of the cover layer 30, to form and to maintain the hairy structure 32 of the cover layer 30.

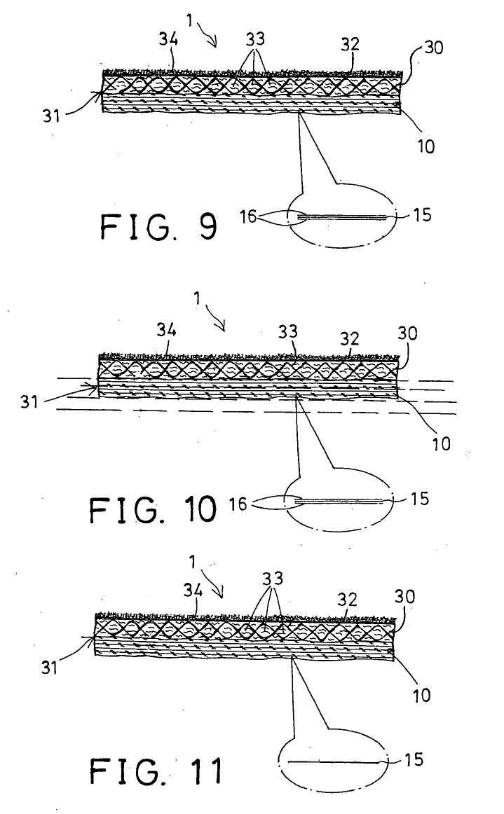

The cover layer 30 may then further be treated with or dipped in polyurethane (PU) solutions or materials 34, as shown in FIG. 8, or has the PU materials 34 optionally or selectively or partially engaged into the cover layer 30, such as engaged into about one half (½) of the thickness of the cover layer 30, and then as shown in FIG. 9, the PU materials 34 may then optionally or selectively or fully engaged into the cover layer 30, or optionally or selectively or completely engaged into the whole thickness of the cover layer 30.

It is to be noted that the fibers or threads 15 of the basic layer 10 is coated or applied or covered with the wax outer layer 16, such that the PU materials 34 will not be engaged onto or applied or covered onto the fibers or threads 15 while treating or dipping the basic layer 10 and the cover layer 30 of the artificial leather 1 into the polyurethane (PU) solutions or materials 34, due to the application of the wax outer layer 16 on the fibers or threads 15 of the basic layer 10.

After the PU materials 34 have been solidly engaged onto the cover layer 30, such as engaged onto the fibers or threads of the hair members 32 or the hairy structure 32 of the cover layer 30, to form or to simulate the artificial leather products, the basic layer 10 of the artificial leather 1 may then be treated, such as heated, or dipped with melting solution or other chemical solutions (FIG. 10), to melt or to remove the wax outer layer or the wax material 16 from the fibers or threads 15 (FIG. 11). The basic layer 10 will thus be provided for directly engaging onto the users, for allowing the users to feel comfortable, and to prevent the cover layer 30 and the PU materials 34 from directly contacting with the users.

It is to be noted that the provision or the applying or the covering of the wax outer layer 16 onto the fibers or threads 15 may protect the fibers or threads 15, and may prevent the fibers or threads 15 from being coated with the PU materials 34, such that the quantity of the PU materials may be decreased, and such that the artificial leather product may include a decreased light or may include a light weight character. In addition, the cover layer 30 may also be formed by such as warp knitting or stitching operations with needles 14 or the like, to form and to provide the perforations 33 therein, and thus to facilitate the air circulating effect or the air perforation or permeating character to the cover layer 30 of the artificial leather.

In addition, after the PU materials 34 have been solidly engaged onto the cover layer 30 to form an outer leather layer, the wax outer layer or the wax material 16 may then be removed from the fibers or threads 15 of the basic layer 10, such that the fibers or threads 15 of the basic layer 10 will be exposed and will not have the wax material 16 and the PU materials applied thereon, to allow the users to contact with the basic layer 10 that is a skin-contact layer and that is made of formed with the fibers or threads 15, and to prevent the cover layer 30 and the PU materials 34 from directly contacting with the users, and thus to allow the users to feel comfortable.

Furthermore, the wax material 16 and the PU materials may be removed and prevented from being attached or applied onto the fibers or threads 15 of the basic layer 10, such that the cloth inner or basic layer 10 may further include a decreased weight, and may also be formed with a number of perforations within the cloth inner or basic layer 10, for facilitating the air circulating effect to the artificial leather.

Accordingly, the artificial leather product in accordance with the present invention includes a cloth inner or basic layer for comfortably contacting with users, and for preventing an outer layer of rubber or chemical or artificial materials from being contacted with the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An artificial leather comprising:
a basic layer including a plurality of longitudinal filaments and a plurality of lateral filaments coupled to said longitudinal filaments, said longitudinal and said lateral filaments being formed by a thread having a wax outer layer applied thereon,
a cover layer secured onto said basic layer, and including a plurality of hair members provided on top thereof, to form a hairy structure, and
a PU material engaged and applied onto said hair members of said cover layer, to form said artificial leather, and
said wax outer layer being removed from said basic layer after said PU material has been engaged onto said cover layer, to prevent said PU material from being engaged into said basic layer, to decrease a weight of said basic layer, and to provide an air circulating effect to said basic layer, and to allow said basic layer to comfortably contact with users, and to prevent said PU material from being directly contacting with users.
